(19) United States
(12) Patent Application Publication
(10) Pub. No.: US 2024/0100726 A1
(43) Pub. Date: Mar. 28, 2024

(54) Blade for Oscillating Power Tool

(71) Applicant: C4 Carbides Limited, Newmarket (GB)

(72) Inventor: Chris Norman, Newmarket (GB)

(21) Appl. No.: 18/532,295

(22) Filed: Dec. 7, 2023

Related U.S. Application Data
(63) Continuation of application No. PCT/GB22/51177, filed on May 10, 2022.

(30) Foreign Application Priority Data
Jun. 10, 2021 (GB) 2108286.2

(51) Int. Cl. B26D 1/00; B23D 61/00; B26D 1/25

(52) U.S. Cl. CPC B26D 1/0006; B23D 61/006; B26D 1/25; B26D 2001/006

(57) ABSTRACT

There is provided a blade for an oscillating power tool having an elongate body fixed to an attachment section. The elongate body is divided into two or more resiliently flexible tongue portions, and each tongue portion includes a cutting portion distal from the attachment section. A depth stop may be attached to the elongate body. There is also provided a method of using an oscillating power tool. In the method, a power tool is activated to oscillate a blade. The oscillating blade is inserted into a channel filled with material, and the power tool is twisted to cause the tongue portions to engage at least opposing walls of the channel.

### CROSS-REFERENCE TO RELATED PATENT APPLICATION

This application is a continuation of PCT/GB2022/051177, filed May 10, 2022, which claims the benefit of and priority to GB Application No. 2108286.2, filed Jun. 10, 2021, which are incorporated herein by reference in their entireties.

### FIELD OF THE INVENTION

This application relates to a blade for an oscillating power tool and in particular a blade for an oscillating multitool.

### BACKGROUND TO THE INVENTION

Oscillating power tools have an output shaft that oscillates at high speed about an axis to which a blade is attachable, with oscillating multitools configured to be used with different types of attachments. Oscillating multitools can be used for a variety of different tasks such as sanding, cutting, grinding, polishing and grout removal.

### SUMMARY OF THE INVENTION

In accordance with the invention there is provided a blade for an oscillating power tool comprising an elongate body fixed to an attachment section, which is typically connectable to an oscillating power tool, wherein the elongate body is divided into two or more resiliently flexible tongue portions, each tongue portion comprising a cutting portion distal from the attachment section. Such a blade as adapted to be used with an oscillating power tool, including an oscillating multitool, is able to remove grout, silicone or other filler materials from a channel, for example between adjacent tiles, bricks or slabs.

The tongue portions are preferably disposed in a common plane so as to be co-planar when the blade is not in use, and in use capable of independent flexible movement to lie in different planes, restoring to a co-planar rest position when not in use.

Preferably the elongate body has a longitudinal length extending from the attachment section to an outer edge of the cutting portion and each tongue portion has a length between 30 to 80% of the longitudinal length.

The elongate body is desirably between 0.5 to 3 mm thick and preferably made of carbon steel which assists with flexibility and enabling movement of the tongue portions with respect to each other.

The elongate body may comprise at least one slit, a tongue portion disposed on each side of the slit. If desired a plurality of slits may be provided, with for example two slits to create three tongue portions or three slits to divide the elongate body into four tongue portions.

Preferably the cutting portion comprises a circular arc and may comprise abrasive material such as particles of Tungsten Carbide or diamond.

A depth stop may be attached to the elongate body to limit depth of penetration of the blade, which is particularly of use when aiming to remove material to a partial depth rather than entirely remove material.

Preferably the depth stop is secured to at least two tongue portions.

In accordance with a further aspect of the invention, there is provided a method of using an oscillating power tool attached to a blade with two or more resiliently flexible tongue portions as aforesaid, the method comprising activating a power tool to oscillate a blade, inserting the oscillating blade into a channel filled with material, and twisting the power tool to cause at least two of the tongue portions to engage opposing walls of the channel. This creates deflection of the two or more tongue portions to at least partially extend laterally across the channel rather than the tongue portions just extending linearly along the channel.

### BRIEF DESCRIPTION OF THE DRAWINGS

The invention will now be described, by way of example, with reference to the accompanying drawings in which:

FIG. 1 is a schematic diagram of an oscillating power tool with blade;

FIG. 2 is a perspective view of a first embodiment of a blade in accordance with the invention;

FIG. 3 is a perspective view of a second embodiment of a blade in accordance with the invention;

FIG. 4 is a perspective view of the second embodiment with an optional depth stop; and

FIGS. 5A and 5B provide an explanatory diagram for describing use of the blade.

### DETAILED DESCRIPTION

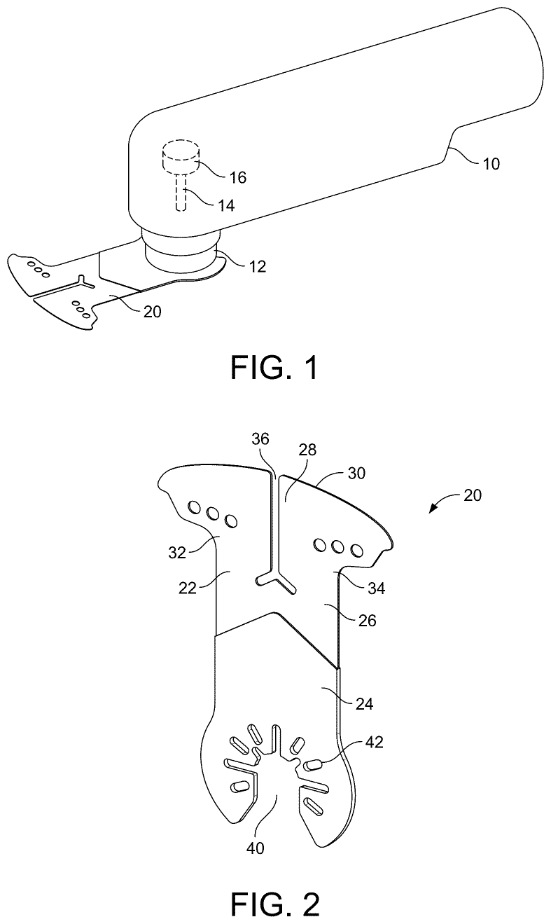

An oscillating power tool 10, such as an oscillating multitool, is shown in FIG. 1 and comprises an attachment mechanism 12 for releasably securing different accessories to oscillating spindle 14 driven by motor 16. Blade 20 is shown connected to attachment mechanism 12.

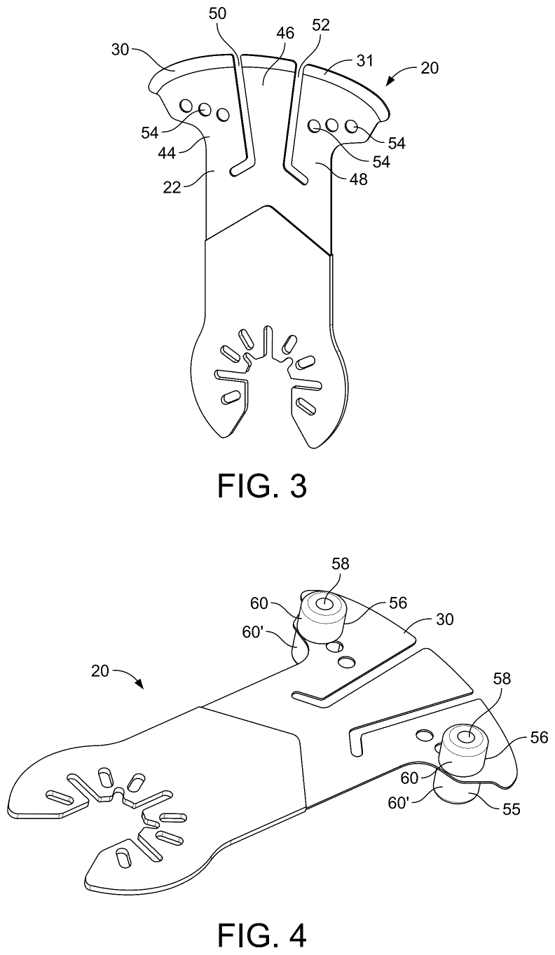

A first embodiment of blade 20 as shown in FIG. 2 comprises elongate body 22 and attachment section, or tang, 24 configured to secure to attachment mechanism 12. Elongate body 22 is substantially T-shaped comprising elongate portion 26 and cutting portion 28 shaped as a circular segment and positioned at an upper end of elongate portion 26 distal from attachment section 24. Cutting portion 28 extends beyond the sides of elongate portion 26 and comprises an outer curved cutting edge 30 on which abrasive material, for example particles 31 of Tungsten Carbide or diamond, is typically deposited, see FIG. 3.

Cutting portion 28 is split centrally into two tongue sections 32, 34 by slit 36 extending from outer cutting edge 30 towards attachment section 24, slit 36 reaching approximately two-thirds down elongate body 22, and thus approximately two-thirds down the longitudinal length of elongate body 22. Tongue sections 32, 34 are resiliently flexible and co-planar at rest as shown in FIG. 2, capable of being flexed independently to lie temporarily in different planes and then restoring to their rest position. Elongate body 22 is typically made from 1 mm thick carbon steel, with elongate portion 26 around 20 mm wide and cutting portion 28 around 75 mm wide.

Attachment section 24 is formed with a plurality of apertures 40, 42 configured in a pattern which enables securing to attachment mechanism 12 of oscillating tool 10.

A second embodiment of blade 20 is shown in FIGS. 3 and 4 with three resiliently flexible tongues 44, 46, 48 resulting from elongate body 22 being trisected by two angled slits 50, 52. Outer tongues 44, 48 substantially correspond to the shape of the tongues in the first embodiment, with central tongue 46 substantially triangular in shape. Three apertures 54 formed in each of outer tongues 44, 48 are configured to receive an optional depth stop 55 to limit how far blade 20 can be inserted within a material.

Depth stop 55 comprises a pair of spacer elements 56, each spacer element 56 comprising a central metal pin 58 extending through the tongue portion and on which are mounted a pair of polyurethane cylinders 60, 60′, the cylinders disposed respectively on upper and lower faces of each tongue as shown in FIG. 4. The first embodiment as shown in FIG. 2 can also be used with such a depth stop. Apertures 54 are disposed on an angled line so as to allow blade 20 to be inserted to different depths depending on which apertures spacer elements 56 are positioned in.

Depth stop 55 ensures consistency of depth of insertion of the blade into a channel so that a uniform depth of grout, silicone, mortar or other filler material can be removed during operation of tool 10. Each spacer element 56 is located in the aperture corresponding to the required depth of insertion, this being the distance from the aperture to cutting edge 30. If a user wishes to partially remove material to a depth of 2 mm, for example, then an aperture positioned 2 mm below the outer cutting edge 30 of the blade will be selected. In use cylinders 60, 60′ will track along a hard surface associated with a filled channel, for example tiles adjacent a channel filled with grout, and so prevent the oscillating blade descending too far into the channel. By using such a depth stop 55, material is removed to a uniform depth ensuring a substrate beneath the material is not damaged and as the old material is removed to a uniform depth, application of replacement filler material is simplified.

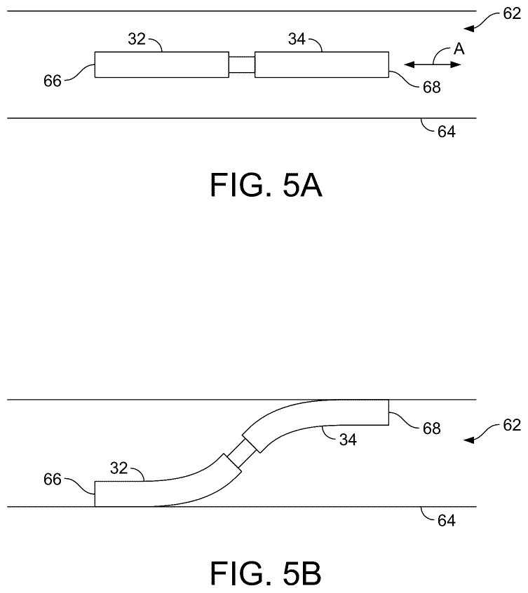

Use of blade 20 to remove grout or other filler material will now be explained using FIGS. 5A and 5B. When tool 10 is used to at least partially remove a substance 62 from a filled channel 64, see FIGS. 5A and 5B, tool 10 is switched on and oscillating blade 20 plunged into channel 64. Typically channel 64 is around 3 mm wide for grout between tiles and around 10 mm for a mortar joint between bricks. Blade 20 oscillates in the direction of arrow A, so substantially parallel to the length of channel 64, see FIG. 5A. The user applies a gentle rotational movement or twist to tool 10 until outer edges 66, 68 of each tongue portion 32, 34, and thus the outer edges of the split outer curved cutting edge 30, engage with opposing channel edges and flex in opposing directions as shown in FIG. 5B. This results in cutting edge 30 extending in a lateral direction across channel 64, rather than just extending linearly in the longitudinal direction of channel 64. This lateral deflection of the tongue portions allows cutting edge 30 to contact material across the channel, instead of just contacting material along the longitudinal length of the channel. In this way the material in the channel, such as such as grouting in a gap between tiles, can be removed in one pass along the channel. This is an improvement over prior art blades used for grout removal where successive passes up and down the channel, adjusting the lateral position of the blade in the channel each time, are required to remove all the grout.

A similar process takes place during use of the blade as shown in FIGS. 3 and 4 with outer tongues 44, 48 flexing as they engage the outer edges of channel 64 and central tongue 46 also flexing to extend at least partially laterally across channel 64.

The dimensions of blade 20 can be adjusted depending on the required use with wider blades used for wider joints such as can be encountered with paving slabs or bricks. For wider blades, and as shown for the second embodiment, preferably a plurality of slits are formed into cutting portion 28 so as to increase the number of tongue portions. Thus, for example, two slits can be used to provide three tongue portions or three slits to provide four tongue portions.

Blade 20 can be formed as a separate attachment portion and cutting portion with these typically secured together by welding or other types of permanent fixture such as rivets. Alternatively blade 20 can be formed as a single piece.

What is claimed is:

1. A blade for an oscillating power tool, comprising:
an elongate body fixed to an attachment section,
wherein the elongate body is divided into two or more resiliently flexible tongue portions, each tongue portion comprising a cutting portion distal from the attachment section.

2. The blade according to claim 1, wherein the tongue portions are disposed in a common plane.

3. The blade according to claim 1, wherein the elongate body has a longitudinal length extending from the attachment section to an outer edge of the cutting portion and each tongue portion has a length between 30 to 80% of the longitudinal length.

4. The blade according to claim 1, wherein the elongate body comprises a thickness in a range from 0.5 mm to 3 mm.

5. The blade according to claim 1, wherein the elongate body comprises at least one slit, one of the tongue portions disposed each side of the slit.

6. The blade according to claim 1, wherein the elongate body comprises two slits to provide three tongue portions.

7. The blade according to claim 1, wherein the elongate body comprises three slits to provide four tongue portions.

8. The blade according to claim 1, wherein the cutting portion comprises a circular arc.

9. The blade according to claim 1, wherein the cutting portion comprises abrasive material.

10. The blade according to claim 1 formed from carbon steel.

11. The blade according to claim 1, wherein the cutting portion extends beyond the sides of elongate portion and comprises an outer curved cutting edge.

12. The blade according to claim 1, further comprising a first line of apertures disposed in the cutting portion and a second line of apertures disposed in the cutting portion, wherein apertures of first and second lines of apertures are each configured to receive a depth stop such that the first line of apertures and second line of apertures define a plurality of depths for positioning of the cutting portion.

13. The blade according to claim 12, wherein the plurality of depths defined by the first line of apertures and the second line of apertures is at least 3 depths.

14. The blade according to claim 1, wherein a depth stop is attached to the elongate body.

15. The blade according to claim 14, wherein the depth stop is secured to at least two tongue portions.

16. The blade according to claim 14, wherein the depth stop comprises a central metal pin extending through a tongue portion of the elongate body and wherein a pair of polyurethane cylinders are mounted on the pin on each side of the tongue portion.

17. A method of using an oscillating power tool attached to a blade according to claim 1, the method comprising:
activating a power tool to oscillate a blade;
inserting the oscillating blade into a channel filled with material; and
twisting the power tool to cause the tongue portions to engage at least opposing walls of the channel.

18. The method of claim 17, further comprising attaching one or more depth stops to the elongate body to control a depth into which the blade is inserted into the channel.

19. The method of claim 18, wherein attaching the one or more depth stops to the elongate body further comprises inserting a pin through an aperture in the elongate body and providing cylinders on the pin on opposite sides of the elongate body.

20. The method of claim 17, wherein, prior to twisting, the two or more tongue portions are disposed in a common plane and wherein, after twisting, portions of the two or more tongue portions deflect out of the common plane.
